(19) United States
(12) Patent Application Publication
(10) Pub. No.: US 2025/0031820 A1
(43) Pub. Date: Jan. 30, 2025

(54) PROTECTIVE CASE WITH ATTACHMENT INTERFACE

(71) Applicant: Otter Products, LLC, Fort Collins, CO (US)

(72) Inventor: STEPHEN J. LEWANDOWSKI, Broomfield, CO (US)

(21) Appl. No.: 18/768,693

(22) Filed: Jul. 10, 2024

Related U.S. Application Data
(60) Provisional application No. 63/528,768, filed on Jul. 25, 2023.

(51) Int. Cl. A45C 13/00; A45C 11/00; A45C 13/10

(52) U.S. Cl. CPC A45C 13/001; A45C 11/00; A45C 13/002; A45C 13/1076; A45C 2011/002; A45C 2011/003

(57) ABSTRACT

A protective case for use with an electronic device includes a cavity for receiving the electronic device and an aperture permitting access to a touchscreen interface of the electronic device. The protective case also includes an attachment interface for attaching an accessory to a back of the protective case. The attachment interface has an insertion region having a first width and an attachment region having a second width that is smaller than the first width. The attachment region includes lips on opposing sides of the attachment region. The lips are configured to removably retain the accessory after the accessory is inserted into the insertion region of the attachment interface and moved to the attachment region of the attachment interface.

### CROSS REFERENCE TO RELATED APPLICATIONS

The present application claims priority to U.S. Provisional Patent Application No. 63/528,768, filed Jul. 25, 2023, which is hereby incorporated by reference in its entirety.

### BACKGROUND

Personal electronic devices are commonly used for communication, entertainment, and a variety of other purposes. Examples of personal electronic devices include smartphones, tablet computers, gaming devices, audio players, video players, cameras, portable computers, two-way radios, GPS receivers, and/or other portable devices. As processing power, screen resolution, and other features increase, these devices are being used for an increasingly wide range of purposes. As these devices become an increasingly important part of users' daily activities, it is desirable to have protective cases that not only protect the electronic devices from damage, but also help flexibly adapt the devices to serve other useful purposes and/or perform other functions, including use with various accessories. In some examples, it is convenient to attach accessories or other objects to the personal electronic device and/or to a case for the personal electronic device.

### SUMMARY

In one example, a protective case for an electronic device having a touchscreen interface comprises a cavity for receiving and at least partially enclosing the electronic device and an aperture in the protective case permitting access to the touchscreen interface of the electronic device when the electronic device is installed in the protective case. The protective case also includes an attachment interface for attaching an accessory to a back of the protective case. The attachment interface has an insertion region having a first width and an attachment region having a second width that is smaller than the first width. The attachment region includes lips on opposing sides of the attachment region and the lips are configured to removably retain the accessory after the accessory is inserted into the insertion region of the attachment interface and moved or slid toward the attachment region of the attachment interface until the accessory engages one or more interference features.

While several examples are provided above for purposes of illustration and description, other modifications and variations may be possible in view of the teachings herein. The embodiments described herein illustrate and explain the principles of the concepts and their practical application to enable others skilled in the art to best utilize the invention.

### BRIEF DESCRIPTION OF THE DRAWINGS

FIG. 1 illustrates a front perspective view of a protective case in one example of the invention;

FIG. 2 illustrates a back view of the protective case of FIG. 1;

FIG. 3 illustrates a front view of the protective case of FIG. 1;

FIG. 4 illustrates a close up view of a portion of the view of FIG. 3;

FIG. 5 illustrates a perspective view of the view of FIG. 4;

FIG. 6 illustrates an exemplary accessory for use with the protective case of FIG. 1;

FIG. 7 illustrates a side view of the accessory of FIG. 6;

FIG. 8 illustrates a side perspective view of the protective case and the accessory;

FIG. 9 illustrates the accessory being inserted into the protective case;

FIG. 10 illustrates the accessory attached to the protective case; and

FIG. 11 illustrates a side view of the configuration of FIG. 10.

### DETAILED DESCRIPTION

Electronic devices are increasingly used with protective cases or covers that protect the electronic devices from a variety or forces or elements such as: dropping, impact, scratching, water, dirt, dust, rain, snow, and/or chemicals. As users carry electronic devices with them more frequently and become more interested in using them for a wider variety of tasks, there is an increasing desire to adapt the functionality of these electronic devices using external modules or accessories that provide different functions than those originally provided in the electronic device and/or in the protective case. Removable modules allow a user to selectively adapt their electronic device to perform a number of new or different functions. Some of these removable modules or accessories may have electrical and/or electronic functions and may need to have an electrical interconnection to the electronic device and/or to the protective case. However, some removable modules may not require an electrical connection to one or both of the electronic device and the protective case. In some examples, a removable module may communicate with the electronic device and/or the protective case using one or more types of wireless communication technology. In other examples, it may simply be convenient to attach an accessory to the electronic device or the protective case even though it may have not have anything to do with the electronic device.

In some situations, it may be desirable to attach, detach, and/or use removable modules or accessories with an electronic device without taking the electronic device out of the protective case. Modules may include features and functions such as, but not limited to: communication functions, a supplemental camera, a flash, a lens, a battery, a power source, a power adapter, a solar panel, a game interface, a supplemental display, a sensor, a measurement device, a monitoring apparatus, a medical measurement device, a medical analysis device, an audio component, a video component, a mounting interface, a mounting function, a storage module, a mechanical interface, a wallet, a compartment for storing other objects, an electrical function, an additional electrical interface, and/or a decorative/ornamental attachment. Many other modules, features and functions are possible and the improvements described herein are not to be limited to any particular type of module or module function.

While most of the electronic device cases disclosed herein are described as “protective” cases, the apparatuses and techniques disclosed herein related to removable modules do not necessarily require that the case is protective and could apply to any type of electronic device case, cover, sleeve, sheath, attachment panel, etc. In other examples, the case may be water resistant or water proof for protecting the electronic device from water or other liquids. In yet other examples, the case may have other characteristics, such as but not limited to, chemical resistance and antimicrobial characteristics. Moreover, while the electronic device cases disclosed herein are generally understood to serve as after-market accessories for original equipment electronic devices (i.e., smartphones, tablet computers, gaming devices, audio players, video players, cameras, portable computers, two-way radios, GPS receivers, other portable devices, etc.), the apparatuses and techniques described herein could also be applied to the actual, original, or primary housings of original equipment electronic devices themselves.

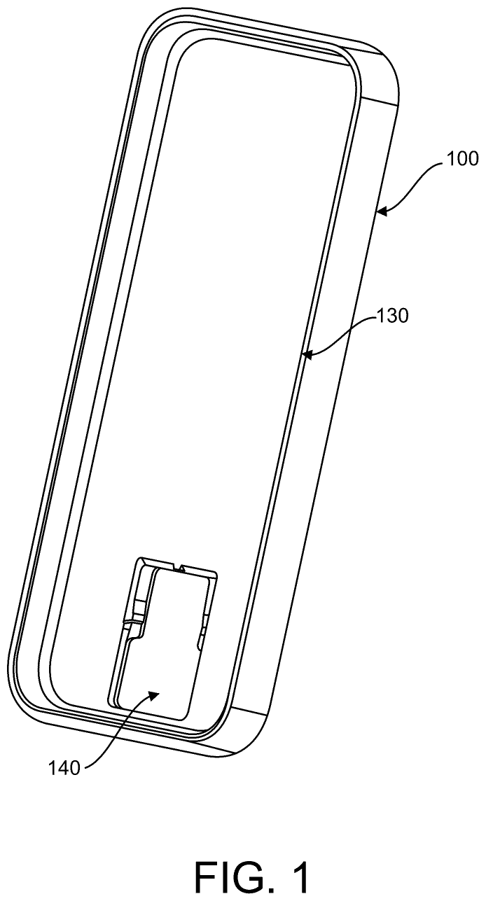

FIG. 1 illustrates a protective case 100 for an electronic device (not illustrated) in one example of the invention. Protective case 100 may be formed from a single material or may include an inner liner and an outer shell. An inner liner may also include cushioning elements and/or be referred to as a cushion layer. Protective case 100 may protect an installed electronic device from external forces, impacts, liquids, sudden acceleration, sudden deceleration, and other forces experienced at outer surfaces of protective case 100. Protective case 100 may contain cavities, coring, reliefs, ribs, channels, recesses, a grid pattern, protrusions, and/or other similar features for holding the electronic device in place, for protecting the electronic device, and/or for potentially reducing the surface area of contact between protective case 100 and the installed electronic device.

Protective case 100 also includes aperture 130 which permits or allows access to at least some portion of an installed electronic device. In one example, aperture 130 permits access to an interactive interface of the electronic device such as a touch screen, a touch screen interface, a resistive touchscreen, and/or a capacitive touchscreen of a smartphone. Aperture 130 may contain one or more lips, ledges, or other features that removably retain the electronic device in the protective case such that it does not easily or readily come out of the protective case, but can still be intentionally removed by a user when desired. Aperture 130 may also include a lip, ledge, protrusion, raised edge, rim, elevated rim, elevated protective rim, or other raised feature around at least a portion of aperture 130 to reduce the chances of a front surface of the installed electronic device from coming into contact with another object or surface, particularly when protective case 100 is laid face down on a flat surface, such as a table.

Protective case 100 may also include an aperture in a back surface for providing optical access and/or an optical path to/from a camera and/or a flash of an installed electronic device. In other words, the aperture may permit use of the camera and/or flash even though the electronic device is installed in protective case 100 and much of the back of the electronic device is covered by protective case 100. The aperture may be covered with a clear, mostly clear, transparent, or mostly transparent membrane or film that protects the camera and/or the flash but also still permits optical access and/or an optical path to/from the camera and/or flash. In some examples, the membrane or film may serve a lensing function and/or provide an optical effect.

Protective case 100 provides protection for an installed electronic device against external forces by reducing or eliminating transfer of those forces to the installed electronic device, as well as providing a relatively soft or compliant contact surface for the installed electronic device. The relatively soft contact surface can resist scratching, scraping, marring, and/or rub marks. While providing protection, protective case 100 enables a user to still use the electronic device while it is in protective case 100.

Protective case 100 also includes attachment interface 140 for attaching one or more accessories as described in more detail below. Attachment interface 140 may be an aperture which extends through the back surface of protective case 100 as illustrated in FIG. 1 or it may be a cavity or recess on a back side of protective case 100 which does not extend all the way through the back wall. In another example, attachment interface 140 is implemented in an outer layer as in FIG. 1, but protective case 100 may also include an inner liner or cushion liner on an inside surface which covers attachment interface 140 from the inside of the case.

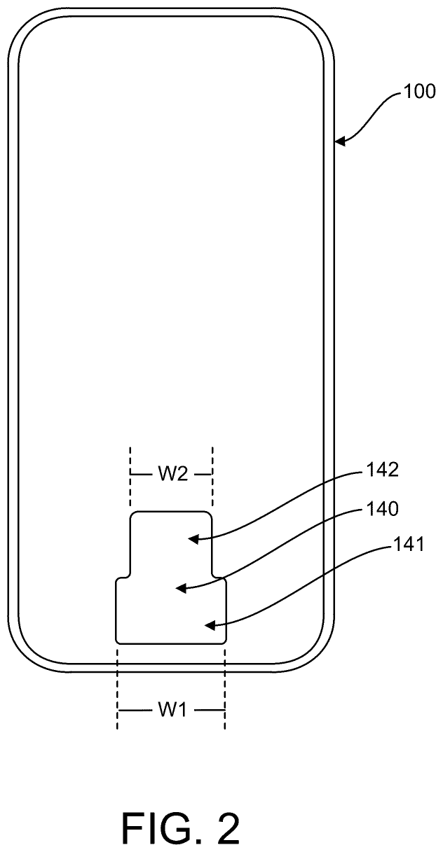

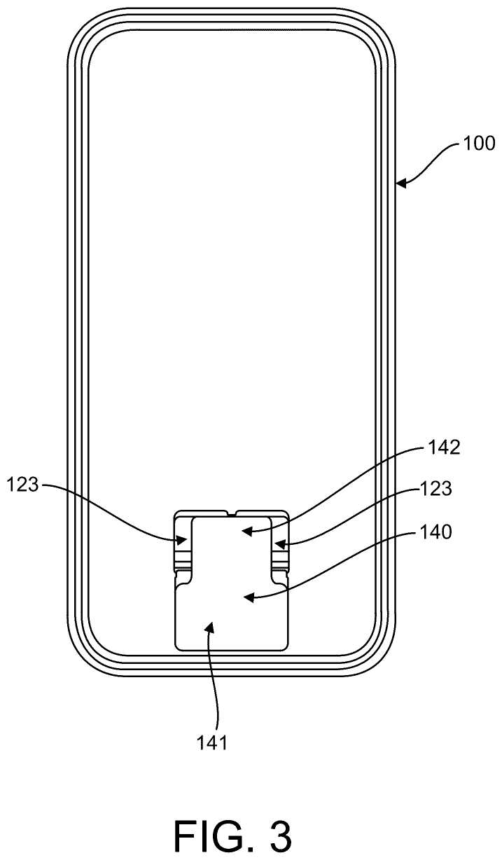

FIG. 2 illustrates a back view of protective case 100. Attachment interface 140 includes two regions, an insertion region 141 and an attachment region 142. Insertion region 141 has a width W1 which is wider than width W2 of attachment region 142 thereby providing an overall shape which may also be described as a ‘key’ shape. FIG. 3 illustrates the front side of protective case 100 which is a view of the opposite side illustrated in FIG. 2. Attachment region 142 also includes lips 123 which result in it having the narrower width W2 illustrated in FIG. 2. Lips 123 may also be referred to as ledges, tabs, or shelves. As described in further detail below, an accessory, module, or removable module is removably attached to protective case by sliding corresponding lips, ledges, tabs, or shelves of the accessory under lips 123.

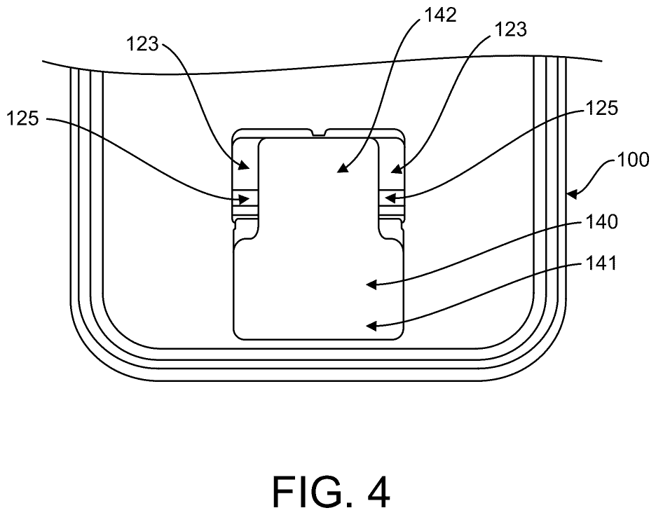

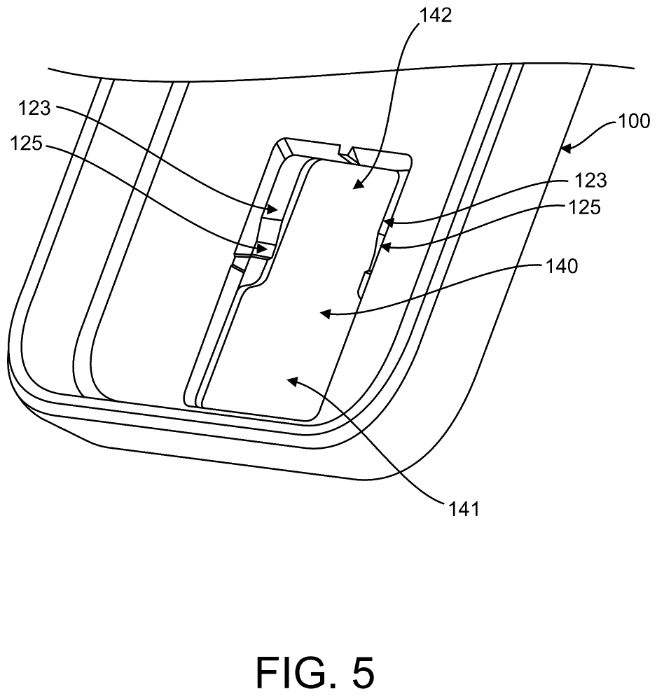

FIG. 4 illustrates a close up view of a portion of the view of FIG. 3. FIG. 4 illustrates that lips 123 may also include interference features 125 which are discussed in further detail below. Interference features 125 may include a recess, a notch, an indent, a tab, a detent, a raised portion, a ridge, a protrusion, and/or a cavity which causes an interference fit, friction fit, or snap fit with an accessory once it is inserted to or past a specified point. These features cause the accessory to tend to stay attached to or engaged with protective case 100 and reduce the chances of unintended detachment until a larger force is intentionally applied by a user to remove the accessory from protective case 100. In some examples, one or more interference features may exist at other locations on attachment interface 140 in addition to or in place of interference features 125. FIG. 5 illustrates a perspective view of the portion view of FIG. 4. FIG. 5 illustrates one example in which interference feature 125 includes a ramped recess or portion along lip 123. The ramped portion assists a user in overcoming the friction or interference fit. The interference features disclosed herein may also include dovetail features and/or a draft.

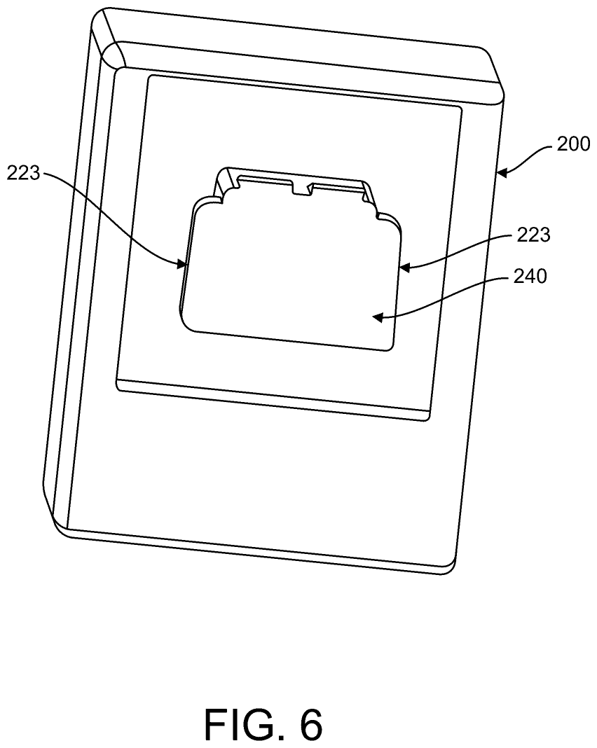

FIG. 6 illustrates an exemplary accessory 200 which may be used with protective case 100 and/or an installed electronic device. Accessory 200 may be any type of module or object that is removably and/or temporarily attached to protective case 100. Accessory 200 is illustrated as a rectangular block but may have any shape or size. Accessory 200 includes an attachment interface 240 which is compatible with, corresponds to, interfaces with, is complementary to, and/or engages attachment interface 140 of protective case 100. Attachment interface 240 of accessory 200 includes wings 223 which are configured or adapted to engage lips 123 of attachment interface 140 of protective case 100. As described in more detail below, wings 223 are configured or adapted to be compatible with, complementary to, correspond to, interface with, overlap, slide under, and/or slidably engage lips 123.

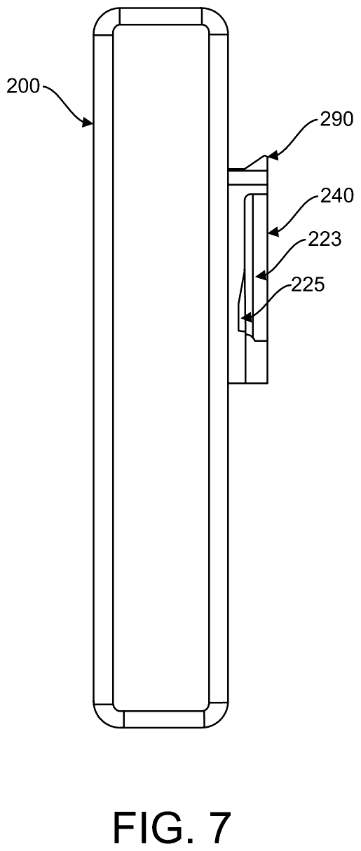

FIG. 7 illustrates a side view of accessory 200 of FIG. 6. FIG. 7 illustrates that wing 223 has a recess or cavity underneath it which makes it configured or adapted to be compatible with, complementary to, correspond to, interface with, overlap, and/or slidably engage lips 123 of attachment interface 140. Attachment interface 240 also includes an interference feature 225 for engaging or snapping into interference feature 125 of attachment interface 140. Interference feature 225 may include a ramp, a recess, a notch, an indent, a tab, a detent, a raised portion, a ridge, a protrusion, and/or a cavity which causes an interference fit or snap fit with another object, such as protective case 100, once it is inserted to or past a specified point. The engagement resulting from the interference or snap fit causes accessory 200 to tend to stay attached or engaged with protective case 100 and reduce the chances of unintended detachment until a greater, intentional force is applied by a user to intentionally remove accessory 200 from protective case 100. Attachment interface 240 may also include other engagement or alignment features, such as alignment feature 290.

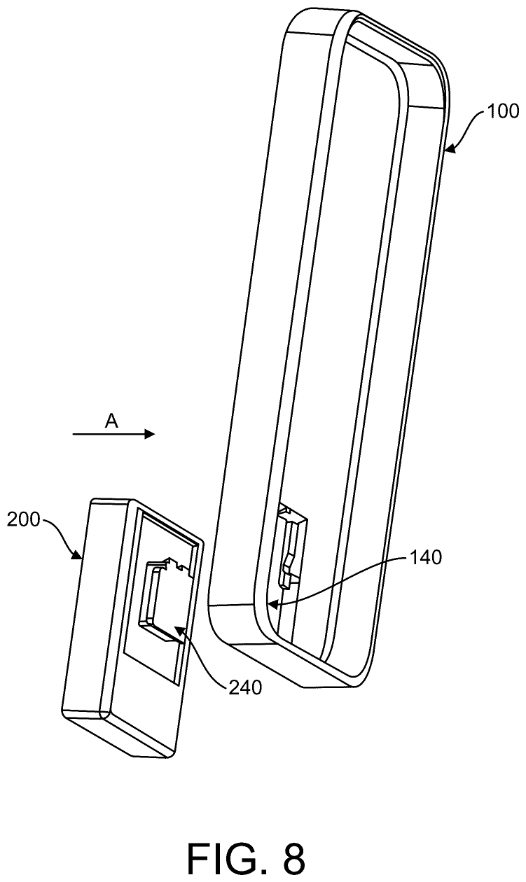

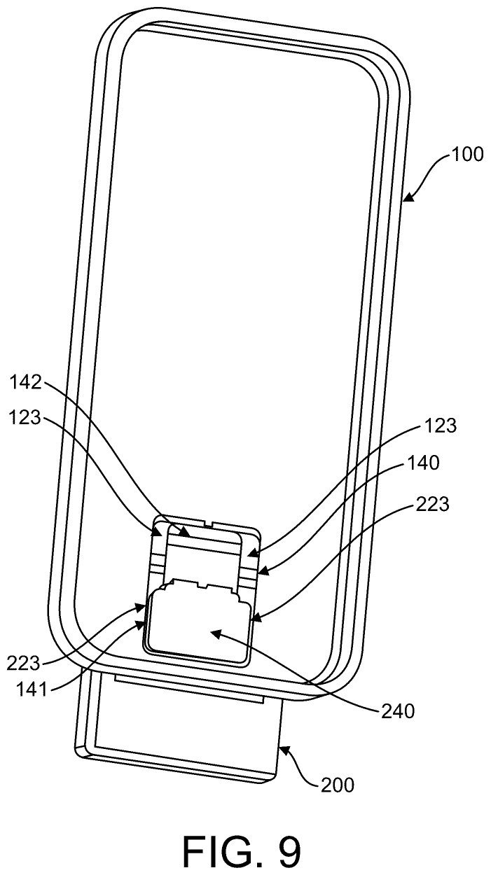

FIG. 8 illustrates a side perspective view of protective case 100 and accessory 200. Accessory 200 is moved in the direction of arrow A to engage it with protective case 100. FIG. 9 further illustrates the process of attaching accessory 200 to protective case 100. Specifically, attachment interface 240 of accessory 200 has been into and through insertion region 141 of attachment interface 140 of protective case 100. The width of attachment interface 240 is less than and fits through width W1 of insertion region 141 (also see FIG. 2). Wings 223 are positioned or configured such that they extend closer to the front of protective case 100 (out of the page) than lips 123 when accessory 200 is pushed all the way into insertion region 141 of attachment interface 140. Beneficially, attachment interface 140 does not have to extend all the way to or breach the bottom edge of protective case 100. This allows features which may extend around the perimeter or bottom of edge of protective case 100 to not have to be interrupted or modified to accommodate the attachment features and interface disclosed herein.

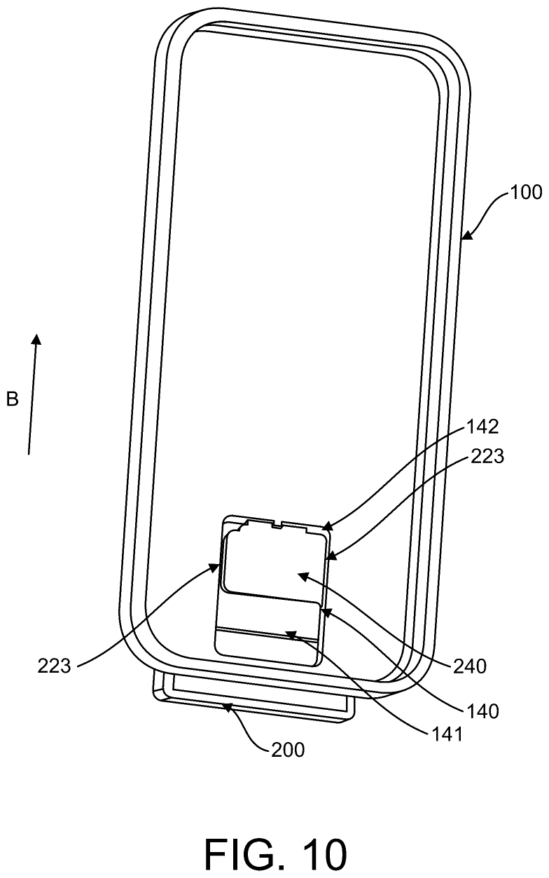

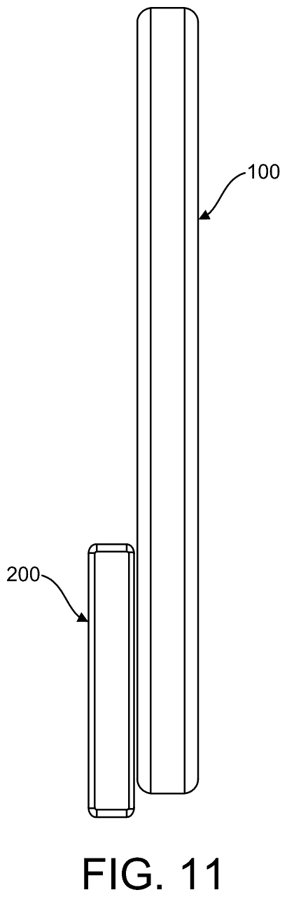

FIG. 10 illustrates accessory 200 attached to protective case 100 after it has been pushed, slid, moved, and/or transitioned from the position illustrated in FIG. 9 in the direction of arrow B. Attachment interface 240 of accessory 200 is now primarily or substantially located in attachment region 142 of attachment interface 140 of protective case 100. Wings 223 are now over lips 123 preventing accessory 200 from being removed from attachment interface 140 in a perpendicular direction. Interference features 225 of accessory 200 may have seated in, snapped into, engaged with, and/or flexed into interference features 125 of attachment interface 140. This tends to hold accessory 200 in the position illustrated in FIG. 10 until a user intentionally exerts a deliberate or significant force in a direction opposite the arrow B to remove accessory 200 by overcoming the inherent force of the engaged interference features. FIG. 11 illustrates a side view of the configuration illustrated in FIG. 10.

In some situations, various accessories may be designed to have different levels of engagement and/or disengagement force with protective case 100 to accomplish different objectives. Accessories may be identified and/or marketed as having higher or lower levels of interference, engagement, and/or disengagement force. A higher engagement and/or disengagement force may be desirable for some accessories because these accessories are expected to be removed from the protective case infrequently. A higher engagement and/or disengagement force may also be desirable for some accessories because these accessories are larger or heavier and more susceptible to being accidentally disengaged due to handling, movement, dropping, or jarring. A higher engagement and/or disengagement force may also be desirable for some accessories due to user preference.

In other situations, a lower engagement and/or disengagement force may be desirable for some accessories because these accessories are expected to be attached to and removed from the protective case frequently. A lower engagement and/or disengagement force may also be desirable for some accessories because these accessories are smaller or lighter and less susceptible to being accidentally disengaged due to handling, movement, dropping, or jarring. A lower engagement and/or disengagement force may also be desirable for some accessories due to user preference.

Using the techniques disclosed herein, a user may beneficially remove an accessory from a protective case when it is not needed and may do so without removing the electronic device from the protective case. Removing the accessory provides several benefits including: the ability to easily switch to a different accessory, not having to carry around a module when it is not needed, the ability to let someone else use the accessory, and/or the ability to remove the accessory for charging while still using the protective case/electronic device. A system with a standard interface allows a wide variety of accessories to be interchangeable and/or manufactured or supplied by a number of providers.

In some examples, any of the protective cases or covers described herein may be used with or without an accessory removable module attached. Beneficially, a user may attach an accessory or module only when needed. In other examples, two or more accessories or removable modules may be simultaneously attached to a single protective case.

In some examples, a removable module may be complementary to a function provided by the case. For example, a case may provide supplementary battery power to the electronic device while a removable battery module also contains a battery and provides even more supplementary power to the case and/or to the electronic device. Further, the removable battery module can be removed and temporarily replaced with a module having other functions.

In some examples, the protective case disclosed herein may be configured with one or more accessories or modules in the form of a kit. In some examples, a cover for attachment interface 140 may be included which covers attachment interface 140 when it is not in use.

The elements, components, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “in other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure has been presented for purposes of illustration and description. Other modifications and variations may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention except as limited by the prior art.

1. A protective case for an electronic device having a touchscreen interface, the protective case comprising:
a cavity for receiving and at least partially enclosing the electronic device;
an aperture in the protective case permitting access to the touchscreen interface of the electronic device when the electronic device is installed in the protective case; and
an attachment interface for attaching an accessory to a back of the protective case, wherein the attachment interface has an insertion region having a first width and an attachment region having a second width that is smaller than the first width, wherein the attachment region includes lips on opposing sides of the attachment region, and wherein the lips are configured to removably retain the accessory after the accessory is inserted into the insertion region of the attachment interface and moved to the attachment region of the attachment interface.

2. The protective case of claim 1 wherein the attachment region of the attachment interface further includes one or more interference features proximate the lips of the attachment region for removably retaining the accessory.

3. The protective case of claim 2 wherein the one or more interference features provide an interference fit between the protective case and the accessory.

4. The protective case of claim 3 wherein the interference fit is a snap fit.

5. The protective case of claim 3 wherein the one or more interference features include a ramped portion.

6. The protective case of claim 1 wherein the aperture in the protective case permitting access to the touchscreen interface of the installed electronic device includes a raised protective rim.

7. A kit for use with an electronic device having a touchscreen interface, the kit comprising:
an accessory; and
a protective case including:
a cavity for receiving and at least partially enclosing the electronic device;
an aperture in the protective case permitting access to the touchscreen interface of the electronic device when the electronic device is installed in the protective case; and
an attachment interface for attaching the accessory to a back surface of the protective case, wherein the attachment interface has an insertion region having a first width and an attachment region having a second width that is smaller than the first width, wherein the attachment region includes ledges on opposing sides of the attachment region, and wherein the ledges are configured to removably retain the accessory after the accessory is inserted into the insertion region of the attachment interface and transitioned to the attachment region of the attachment interface.

8. The kit of claim 7 wherein the attachment region of the attachment interface further includes one or more interference features on the ledges of the attachment region for removably retaining the accessory.

9. The kit of claim 8 wherein the one or more interference features provide an interference fit between the protective case and the accessory.

10. The kit of claim 9 wherein the interference fit is a snap fit.

11. The kit of claim 8 wherein the one or more interference features of the attachment region include a ramped portion.

12. The kit of claim 7 wherein the accessory includes an attachment interface configured to engage the attachment interface of the protective case to removably retain the accessory to the protective case.

13. The kit of claim 12 wherein the attachment interface of the accessory includes one or more wings configured to engage the ledges of the attachment interface of the protective case, respectively.

14. The kit of claim 7 wherein the aperture in the protective case permitting access to the touchscreen interface of the electronic device includes an elevated rim.

15. The kit of claim 7 wherein the accessory is configured to electrically interface to the electronic device when the accessory is attached to protective case and the electronic device is installed in the protective case.

16. The kit of claim 7 further including a second accessory configured to be removably attachable to the protective case.

17. A case for an electronic device having a user interface, the case comprising:
a cavity for receiving and at least partially enclosing the electronic device;
an aperture in the case permitting access to the user interface of the electronic device when the electronic device is installed in the case; and
an attachment interface for attaching an accessory to a back of the case, wherein the attachment interface has an insertion region opening having a first width and an attachment region opening having a second width that is smaller than the first width, wherein the insertion region is contiguous with the attachment region, wherein the attachment region includes one or more lips along one or more sides of the attachment region, wherein the one or more lips are adapted to removably retain the accessory after the accessory is inserted into the insertion region of the attachment interface and moved to the attachment region of the attachment interface, and wherein the attachment region of the attachment interface further includes one or more interference features on each of the one or more lips of the attachment region for removably retaining the accessory.

18. The case of claim 17 wherein the one or more interference features provide an interference fit between the case and the accessory.

19. The case of claim 18 wherein the interference fit is a friction fit.

20. The case of claim 17 wherein the electronic device is one of a mobile phone and a tablet computer.
